(19) United States
(12) Patent Application Publication
(10) Pub. No.: US 2025/0155859 A1
(43) Pub. Date: May 15, 2025

(54) ELECTRONIC DEVICE AND METHOD FOR CARRYING OUT ROUNDS AND AUTOMATIC DATA ACQUISITION

(71) Applicant: PETRÓLEO BRASILEIRO S.A. – PETROBRAS, Rio de Janeiro (BR)

(72) Inventor: Rafael Fagundes ROSA CAMPOS, Rio de Janeiro (BR)

(21) Appl. No.: 18/938,529

(22) Filed: Nov. 6, 2024

(30) Foreign Application Priority Data
Nov. 12, 2023 (BR) 1020230236944

(51) Int. Cl. G05B 15/02; G01C 21/00; G06K 7/10; G06V 40/13; G10L 15/26

(52) U.S. Cl. CPC G05B 15/02; G01C 21/3804; G06K 7/10386; G06V 40/1306; G10L 15/26

(57) ABSTRACT

The disclosure describes embodiments of a portable electronic device for measuring process or analytical data, provided with a microprocessor, sensors, and actuators for a broader spectrum of accessibility than that normally adopted in an industrial context, which has as one of its variations a specific ergonomic format, aimed at the particular needs of users of industrial personal protective equipment, which prevents the insertion of data that have not been effectively measured, has RFID communication for identifying an asset and a wireless way to obtain routes and record data of process variables with a time stamp in electronic storage.

### FIELD OF THE DISCLOSURE

The present disclosure is a system for monitoring and operating a process plant, using an electronic manual device for identifying, measuring, collecting, storing, consulting and transferring data. The system uses the identification of an industrial asset as a means of allowing the measurement of some operational variable of the asset. The data is stored in the device until the wireless communication conditions allow the same to be sent to an electronic storage. The means for recording the measurements is characterized by dispensing with the manual typing of the value of the variable.

### BACKGROUNDS OF THE DISCLOSURE

The condition of industrial equipment and processes can be assessed by monitoring some physical variables, for example, pressure, temperature, vibration. There are several approaches currently in use, and the report “Automation of Data Collection Methods for Online Monitoring of Nuclear Power Plants”, published by A. Rashdan and S. Germain by the Idaho National Laboratory in 2018, presents the state of the art with a focus on the nuclear power industry. For asset condition management, three of the methods are most important from an operational point of view: online measurement, robotic inspection and operator rounds.

In online measurement, sensors are normally arranged to assess the condition of equipment and processes and make them available via some electronic interface to a monitoring and control system, for example, an OPC (open platform communications) server, SDCD (distributed digital control system), SCADA (supervisory control and data acquisition) systems, PIMS (process information management system), PAC (programmable automation controller-computer for automation) or PLC (programmable logic controller). There are some current challenges in this approach, for example, the cost of capital expenditure in the design, construction of sensors and industrial networks, operational expenses related to specialized maintenance of instruments and network infrastructure with a high diversity of protocols (for example, Modbus, Profibus, Foundation Fieldbus, HART, MQTT), which require specialized labor. Small ventures in emerging economies, such as, for example, in exploration of mature oil wells in onshore fields in large geographically distributed areas, may have difficulties, both in technical and economic feasibility to install and maintain the infrastructure.

Even where there is plenty of instrumentation installed, other limitations may be present; for example, in some offshore oil and gas businesses, production assets are installed in remote areas, such as terminals and oil platforms hundreds of kilometers from the shore with reduced number of people on board and limited satellite bandwidth to corporate centers on shore, where data analysis at the corporate layer takes place.

It is common practice for certain high-capacity production systems to be integrations of modules built by several different manufacturers, and the integration of all process variables provided by a given module is not always feasible. In this context, the instrumentation is installed, but the integration does not occur satisfactorily during commissioning, which is the last step of the project before operation, a step that in many cases suffers greatly from tight deadlines and delays in previous steps of the project.

Robotic inspections applied using drones are already in the commercial phase when it comes to detecting leaks and tank wall thickness, for example, but they still have application limitations. Inspection via operational rounds of quadruped robots is more flexible and experimental tests in a relevant environment are already taking place in logistics, security and industry. Robotic inspections, in general, are expensive and the level of technological maturity of most solutions does not yet allow for their dissemination in the market.

Operator rounds are the systematic inspection and monitoring of equipment and processes by process operators during inspections in industrial areas during the shift. The technical report “Operator Rounds Guideline: Fundamentals for Operator Rounds”, published by the Electric Power Research Institute in 2017, provides technical and administrative guidance for operations managers in Power Generation companies. During these rounds, statuses are checked, parameters are recorded as necessary, and actions are taken due to abnormal or out-of-specification conditions. The idea is to anticipate appropriate actions before malfunctions or accidents.

In the early days of the process industry, the operational with information collection via clipboard and some forms, was the only way to maintain and control systems.

According to John Matura of Insource Solutions in his publication: “The Importance of Rounds”, the method of collecting information in rounds is challenged as s retired technicians take their knowledge with them, wireless sensing technology becomes widespread in the market and some rounds are replaced by monitoring via sensors. Matura argues that rounds are not only used to collect physical data to support decision-making (a task that any automatic measurement system does), but to be the eyes and ears of the process. During a round, there is identification, documentation, resolution when possible and coverage of any problems of any nature that are found, including those that do not have detection technology installed. And there are problems that, if not identified in advance, can become catastrophic, from the point of view of safety for people, the environment, facilities or financial losses of any magnitude.

Operator rounds are still widely used, being in many contexts the first option due to the need for subjective assessment of the condition of the production system as a whole by the operator. Signals (e.g., sound) with characteristics that would be considered outliers by conventional monitoring systems but that may be significant to human judgment, undesirable or dangerous situations that may become undetectable by conventional instrumentation, in addition to situations not foreseen in risk scenario studies (such as HAZOP, for example) are the main reasons why in loco verification of equipment condition is still used, even with the availability of online instrumented systems.

In some situations, there is an inspection route that is mandatory for legal or regulatory reasons of any kind. In these cases, if the sampling rate required to monitor a given variable is too low, the operator is provided with a way to collect data in loco instead of implementing sensors.

Inspection rounds of equipment installed in explosive atmospheres, such as those recommended by ABNT NBR IEC 60079-17 standard, are not automated in the state of the art, for example. And human judgment is essential, given the diversity of the failures that the installation, operation and maintenance of equipment can present.

Despite advances in the field of industrial instrumentation and control, rounds still remain in some activities, mainly, but not limited to, monitoring vibration and temperature of dynamic equipment components, thickness of static equipment, safety conditions (leaks), inadvertent blocking of alignments of pressure relief devices and various subjective conditions, such as apparent visual quality of the surface of floaters, odor in effluent degradation systems by aerobic biological processes and noise of any kind.

According to the publication “Understanding Process Safety Management”, by Adrian Sepeda, published in 2010 by the American Institute of Chemical Engineers (AIChE), operational procedures are one of the pillars of risk management, which is a key component of risk-based process safety management. Operational procedures can be described as instructions executed by people, which depend on some managerial, logical and physical input conditions, to produce execution of tasks at the output.

Many operational procedures have actions whose workflow is based on physical variables that are measured during the operational round; for example, the next instruction for the operator may be a message that he should increase or reduce the dosage flow rate of a chemical, based on a reactor temperature measurement, for example.

Automation of operational procedures can be carried out in many ways; a successful example was published in 2019 by D. Almeida, E. Cartaxo, N. Barreiros and D. Reis “Implementação de plataforma de automação por dispositivos móveis para gestão operacional em refinaria de petróleo” (“Implementation of an automation platform using mobile devices for operational management in an oil refinery”). Among the advantages of this approach, there can be found improvements in traceability, standardization and consultation of the procedures.

### STATE OF THE ART

The industrial area, despite advances in occupational health and safety in recent years, is still in general an unsafe environment. Operators work in environments with steam traps, relief and safety valves that can go off at any time, equipment that is noisy and emits thermal energy, and they have to be careful with protective barriers against moving, hot and energized parts. They wear clothing that is actually personal protective equipment, which is often heavy and uncomfortable. They wear gloves (in some cases, made of thick steel mesh), helmets, ear protectors that press against the earpiece to reduce noise, boots with toe caps and electrical insulation. They also have to carry a flashlight and a handheld radio, which broadcasts many messages from the team all the time. They also use measuring instruments and a laptop computer, which is a lot of work in itself.

Operational rounds have been integrated into the modern company management systems using laptop computers and, more recently, smartphones. This methodology has become common practice. The report “Best Practices for the Application of Handheld Computers to Operator Rounds”, led by W. Crawford, published by EPRI-Electric Power Research Institute, presents an overview of the challenges faced in the transition from the clipboard to the handheld computer, and some research and development proposals. Among the various proposals for opportunities raised by the EPRI report, it is worth highlighting that the main challenges in research and development are in the field of knowledge related to user experience (UX). Dom Norman and Jakob Nielsen publish the following definition in “The Definition of User Experience (UX)”: “User experience encompasses all aspects of the end user's interaction with the company, its services and products.”

A typical operational round sequence is described below and illustrated in FIG. 1:
1. (a) Get the radio (need for communication in the area) and portable measuring instruments;
2. (b) Synchronize the laptop computer on the control house's wireless network or on the dock connected to the wired network, charge the laptop computer and go to the area;
3. (c) Approach the equipment, unlock the RFID using the laptop computer;
4. (d) Inspect the equipment and on the laptop computer enter data such as process conditions: suction and discharge pressure of fluid machines, if there is abnormal noise, if there is any apparent abnormality, if the oil level is adequate or if there are leaks, gasket drip rate or seal leakage, if the fan protection is intact, if the power cables are intact;
5. (e.1) collect the value of a meter for variable 1, write or enter the measured value 1; (d)
6. (e.2) collect the value of a meter for variable 2, write or type the measured value 2; (e), and so on;
7. (f) Return to the control room to send the route data.

The data collected depends on the industry, and the example provided is contextual. The sequence of items (c) to (e) is repeated for all equipment, wherein a typical round has between 20 and 50 pieces of equipment. The sequence described does not exclude other operational round configurations, nor does it exhaust all possibilities. There may be other variables to be collected with other types of fixed or portable instruments, for example.

In “UX and Interface Design for Embedded Systems”, by Bruce Montgomery, published by the University of Colorado Boulder, accessed in 2021, analysis, research, design, verification and validation techniques applied to the user experience with a focus on on-board systems are reported.

Patent US2013042682A1, DEVICE AND METHOD FOR DETECTING MACHINE VIBRATIONS, by inventors D. Busch, K. Alexander and K. Karl, from 2013, claims a portable vibration measuring device for checking the condition of machines, using some specific methods of measuring acceleration in relevant spatial axes. It has some of the elements of the present disclosure except for not allowing transmission of the measured data for processing, it does not have provision for measuring other types of variables and there is no integration with the datalogger.

Patent WO2015166349A1, titled “TRENDING MACHINE HEALTH DATA USING RFID TRANSPONDERS”, by inventor Alexander Pinkerton, published in 2015, addresses to the problem of collecting continuously sampled data that cannot be continuously transferred. It proposes a device that continuously collects, via radio frequency, health information from a process equipment, stores the same in a memory of an RFID transponder and occasionally transmits the same to a portable RFID reader that the operator uses on an industrial inspection round route. The main claims of this patent are: Installation of a device that monitors the condition of the machine, a transponder that receives and stores the information from such device and the method of obtaining the information and configuration via RFID. It differs from the present disclosure because the data is acquired continuously and stored in a memory, which is read periodically during the operational round via RFID, wherein the present disclosure reads data at the time of the round and transmits the same via communication protocols.

In 2016, the first version of the ANYmal quadrupedal robot was released, as published in the paper “ANYmal—A highly mobile and dynamic quadrupedal robot”, by the author M. Hutter et al. The company that is commercially exploring the robot, Anybotics, will begin testing the viability of its robot in refining and exploration and production areas in 2023, to carry out, in a first step, robotic operational rounds on a subset of relevant variables.

In 2018, SKF launched the SKF Quick-Collect sensor device on the market, which is used to be fixed to a specific point of the equipment and sends temperature and vibration data from that specific point to a smartphone via Bluetooth. Unlike the transponder mentioned in the patent, it is a portable meter that communicates wirelessly with an operational inspection round form in the format of an application. The differences regarding the present disclosure are: it is not used in routine operational rounds, where a small number of variables in large quantities of equipment are evaluated several times a day, but rather in inspection, for vibration analysis; there is no alarm or alert via display, vibration, light alarm or other means for him/her to perform an initial critical analysis of the reading; and does not have RFID reading to ensure that the operator performs the reading.

Patent US2019266575A1, “MODIFYING FIELD WORKFLOWS”, by M. Rohan, L. Graeme, S. Akshay, published in 2018, describes some ways to perform procedure automation, and uses a hydrogen separation plant by adsorption in an oil refinery as an example. It claims the method of receiving a procedure on a mobile device, an information system that comprises storage and transfer of procedures between databases, mobile devices, and a way to change the procedure depending on operating conditions, applied to refining or petrochemical plants. It differs from the present disclosure because the proposed disclosure is a computing hardware support for decision-making in procedure automation, based on variables measured in the field, whereas Rohan's patent describes a method of procedure automation performed in software.

In 2022, patent WO2022002655A1 is published, titled “NETWORK APPARATUS AND SYSTEM FOR THE TAMPER-FREE TRANSMISSION OF DATA OF AN AUTOMATION FIELD DEVICE”, by authors M. Koepke, S. Grahlow and J. Sprenger, which claims an electronic network device that collects data from wireless field industrial automation devices via the OPC UA protocol, and retransmits the same for later display or storage. It is applied for continuous monitoring of variables, and requires dedicated electronics in the device. According to an advantageous embodiment of the system, it is foreseen that the field device is designed to detect a volumetric flow of a process medium in a pipeline, the data from the field device being a volume of the process medium transported in the pipeline in a defined time interval, including an identification of the field device and a time stamp. The field device is a flow rate measuring device, for example, based on the ultrasonic principle, the magnetic-inductive measuring principle or the Coriolis measuring principle. It differs from the present disclosure because it is used to monitor fixed measuring instruments, with a focus on the reliability of measurements that have legal importance, such as fiscal and invoicing measurements.

Also in 2022, patent WO2021013580A1, “METHOD FOR OPERATING A FIELD DEVICE USED IN PROCESS AUTOMATION TECHNOLOGY”, by inventors B. Tschudin, T. Bier, S. Weiss and B. Worreth, was published, where the NFC/RFID connection of a mobile device is used to log in to a configuration system of a field automation device (for example, a control valve or a transmitter). This patent mainly claims the method for operating the equipment, with radio frequency identification being the trigger to launch an application on the mobile device, related to the management of the automation asset, in contexts of, for example, PRM—Plant Resource Manager. The fundamental difference is that in the proposed disclosure, the RFID trigger is used to allow the operator to read the information, so that he/she does not enter information from another piece of equipment and is related to improving the integrity of the information obtained via operational rounds. In Tschudin's patent application, the RFID trigger is used as a means of authenticating a user to configure a device, that is, it is related to ensuring the authenticity of a user who will configure a field device.

The round-assistance equipment of the state of the art have serious usability problems when the operator needs to use gloves, because the touchscreens do not work correctly or there are menus and software options that are too small for correct selection and that prevent the correct usability. The more portable the device is, the smaller the alphanumeric keyboard becomes. However, when the meter is brought close to hot equipment (over 70° C., for example), it is necessary to wear gloves. This makes it difficult to type on the device, which usually has a small alphanumeric keyboard. Therefore, the operator has to put on and take off the gloves every time he or she is going to take the measurement and then type on the laptop. This reduces the efficiency of the task, makes it more tedious for the operator and increases the total duration of the activity. Another effect that may arise is that, over time, the operator may not put on the gloves at some point to take the measurement, which may cause safety problems.

Another problem is related to the number of interactions with the interface. Since the measuring devices and laptop computers were not designed to work together, there is a need to access menus, fields and type values unnecessarily many times, also reducing the efficiency of the task.

In many cases, there is a lack of dynamism in the round routes. It is not possible for a supervisor to quickly edit the route, for example, changing what should be measured and which equipment should be measured due to partial plant shutdowns, or new needs due to critical issues raised by the plant's routine management.

There is a lack of alarms when it comes to the dynamic behavior of time series generated via operational round data. At most, alarms are configured for static situations. Alarms in control systems have several configuration modes. The IEC 62682 “Management of Alarm Systems for the Process Industries” standard, from 2022, is one of the publications that guides alarm configurations for process abnormalities (for example: deviation, discrepancy alarms), which can be implemented in the operational rounds, informing the operator what action he should take after the alarm is announced, since, in process control and monitoring, every abnormality must have an associated action.

It is very difficult to write a short report of a few lines about an abnormality found using touch pens and gloves, or on small alphanumeric keyboards. Industrial environmental conditions can make the task even more difficult.

According to the aforementioned report “Best Practices for the Application of Handheld Computers to Operator Rounds”, by EPRI, in some industrial plants, the operators used to write down measurements on paper and then type the variables in the room, but this practice removes the time stamp from the collected data. It was reported that some operators bypassed the bar code system to avoid having to perform the measurement in loco, and others searched for values available on the SCADA interface, eliminating the redundancy of the activity.

According to the same report, the critical maintenance items for portable computers are the wear of the pin of the parallel data connector of the portable computer, the wear of the monitor screen, worn out by the use of a touch pen, and the loss of the pen itself in an industrial environment.

The present disclosure has peculiar features not met by any commercial solution. One of them would be related to the usability of the device with the use of protective gloves: measurements on equipment that previously required the use of gloves, which prevents touching small screens or relatively small menus. In addition, many equipment have a series of navigation screens to complete a single check, which becomes an impediment for a round that requires many pieces of equipment to be checked (around 50 or more), not to mention a series of parameters to be entered for a single piece of equipment. Some equipment have pre-planned routes, which in some situations would have to be revised, according to the need. Some solutions do not have alerts or alarms for cases of dynamic behavior, when they do have them for equipment with static behavior. Situations like these should require operator action. Abnormal situations require a description in just a few lines, and only one state-of-the-art solution allows observations to be made via audio recording, as if it were a Post-it, which the present disclosure allows with an integrated audio and voice system. The present disclosure allows the creation of a time stamp when recording parameters, since it does not require the operator to type in the found values. Despite being found in the state of the art, the RFID reading solution allows the immediate identification of an asset. The sensor data are recorded automatically, without the need for an operator to type on the screen. The device has wireless communication for data transfer, avoiding the use of cables and serial or USB ports.

### BRIEF DESCRIPTION OF THE DISCLOSURE

The non-limited, illustrative and exemplary embodiment technology refers to a portable device provided with a microprocessor, sensors, RFID communication for asset identification and a wireless way to obtain routes and record process variable data with time stamp in electronic storage, with an ergonomic format and without the need for an alphanumeric keyboard. The sensor data are recorded without the need for manual typing by the operator. Possible applications, but not limited to these, are to support operational rounds or other activities in contexts such as industrial inspection, logistics, health, safety and others.

### BRIEF DESCRIPTION OF THE FIGURES

To assist in identifying the main features of the present disclosure, the figures to which reference is made are presented, as follows:

FIG. 1 shows a usual sequence in steps from (a) to (f) considering an operational round.

FIG. 2 illustrates an embodiment of the present disclosure indicating the positioning of the sensors, navigation buttons, screen, RFID trigger button (or tactile button), rod for manipulating the device, location for biometric identification, port for charging the battery, and the body where the portable computer and its electronics are located.

FIG. 3 shows an example of an organization chart of the electronic architecture of the device hardware related to an embodiment of the present disclosure.

FIG. 4 shows the restriction regarding the viewing angle, considering an OLED display technology and a human being of average height.

FIG. 5 illustrates an implementation of an embodiment related to the standard use case considering the microprocessor controller that combines the basic functionalities of the meter and portable computer.

FIG. 6 details an embodiment of automatic local data collection in the present disclosure, without the need for typing and the possibility of recording notes using speech.

FIG. 7 illustrates an embodiment of an interface method where the user records observations via voice and as a means of recording small status reports of equipment and processes.

FIG. 8 illustrates an embodiment of a method of using the smartphone as a means of managing routes, as a type of IoT gateway.

FIG. 9 shows an embodiment of a method of use in the context of an interface of an embodiment for a small monochromatic screen with interaction of the portable computer with the operator, considering the standard use case where three variables are inserted into the system.

### DETAILED DESCRIPTION OF THE DISCLOSURE

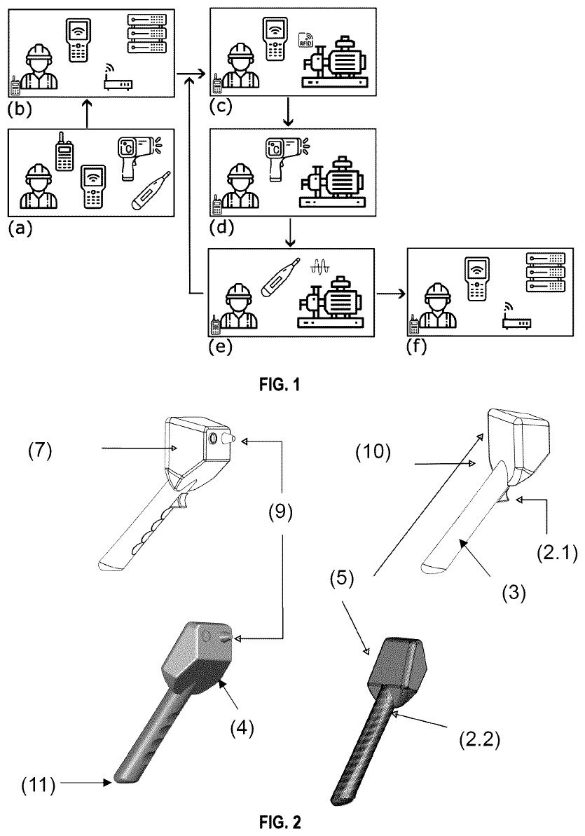

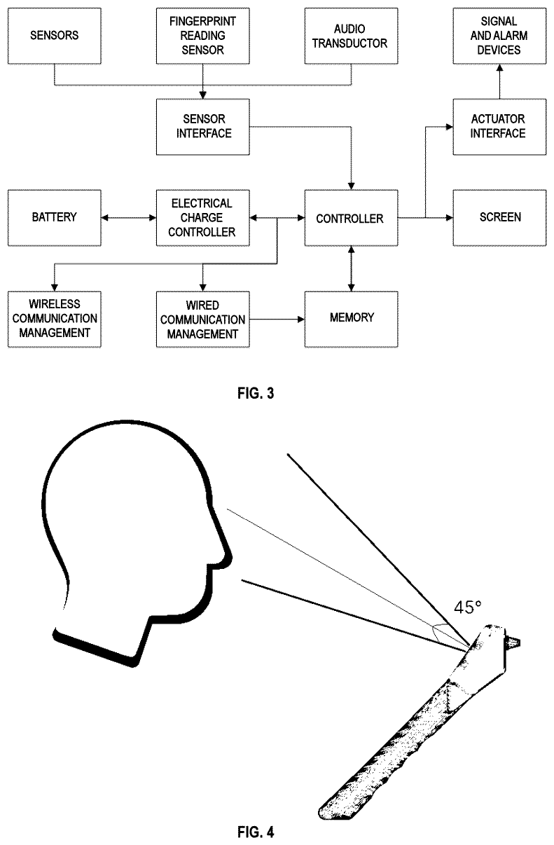

The present disclosure is illustrated in FIG. 2, considering an embodiment and an alternative, in which the embodiment has the integration of sensors and a portable computer, and solves the inconvenience for the operator of carrying several pieces of equipment, as demonstrated in FIG. 1. The alternative embodiment is only a change in the aesthetics and ergonomics of the device in relation to the rod and the body, in addition to the insertion of a tactile button in place of a trigger-type button. This trigger-type (2.1) or tactile (2.2) actuation button, called the main button (2), is strategically positioned on the rod (3) so that it can be actuated by the operator's index finger. This geometric arrangement creates a gun shape and solves the problem of devices that require the use of gloves.

The body (4) of the present disclosure has at least one screen (5), preferably with a screen size of 2.5″ (6.35 cm) to 6.00″ (15.24 cm), which may be colored screens like those found on cell phones or monochrome screens with backlighting.

The electronic system (6), as shown in FIG. 3, has a power management section, where a battery is used, preferably Cylindrical lithium-ion cells, but non-rechargeable batteries may also be used. In the microprocessing system there is further an information processing and storage section. There is another section that has sensor and actuator control devices, as well as voltage controllers.

The interface section has a sound acquisition device (8), preferably using a MEMS transducer, which communicates with the processing section using buses such as I2S (Inter-IC Sound), and user indication controllers, which may be direct current vibration micromotors, LEDS or piezoelectric sound indicators.

There is a section that interfaces with the graphics communication board and the screen (5), preferably being a data input and output device creating an interactive interface with the user (operator).

For user authentication, there is a biometric reader (7), preferably a capacitive one, which captures an image of the fingerprint and uses a dedicated processor, which executes a hardware algorithm to identify the user. This aspect of the disclosure dispenses with the typing of a login and a password, which improves the user experience and dispenses with an alphanumeric keyboard.

The present disclosure in its preferred embodiment has between 2 and 4 push-type buttons (10) with 2 or 4 pins, preferably at the top in relation to the screen. With this, the round task is performed using 4 buttons on a single device instead of using several other auxiliary devices, one of which is a portable computer with multiple buttons and interfaces. Once the data is collected, the operator does not need to look at the screen to know if the data was collected correctly, since the present disclosure also has a notification system using vibration, audible beep and/or LEDs at the top of the device. Such a system assists in cases where there is a need for decision-making by the operator, where the device emits an audible or visual alarm.

The present disclosure has an RFID reader (9) that emits a radio wave, which is captured by the tag's antenna. This causes the tag's chip to transmit the stored information back to the reader. Communication between the tag and the reader is performed without physical contact and over a distance that can be from a few centimeters to several meters.

In ergonomic terms, the field of view is the position of the screen in relation to the most comfortable viewing angle possible for the operator and the rod with which he holds the device. The angle between the reading of the screen and the line of sight covers at least 22.5° of inclination in relation to the normal line to the surface of the screen, as seen in FIG. 4.

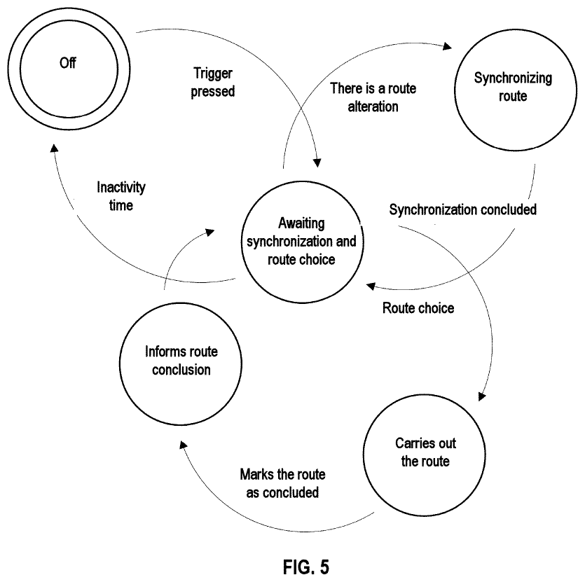

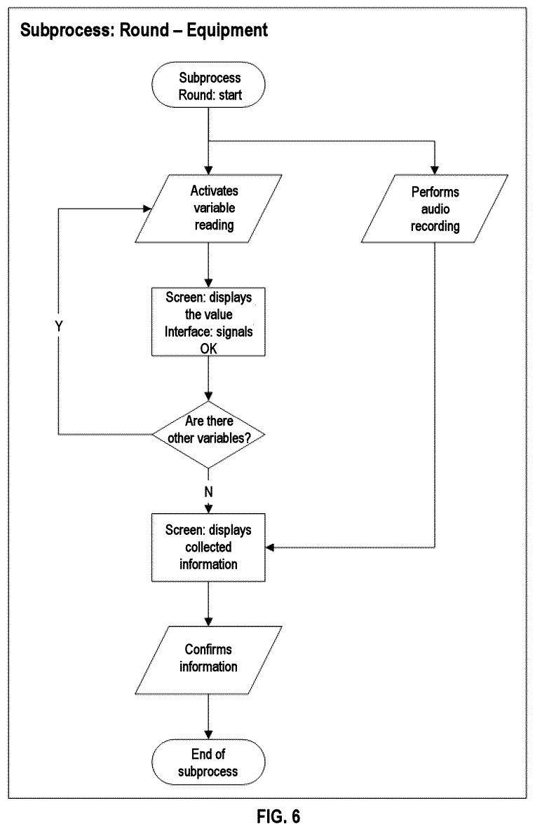

Given that the embodiment of the disclosure allows a new round posture and route planning and execution, a methodology directly aligned with the inventive concept can be implemented. The control method of the microprocessor system (6) of the device is detailed in FIG. 5. When pressing the trigger, the device is initialized, and as soon as it is ready, it begins to actively seek route updates by consulting the upper layer of a network server, for example, when connected to a gateway. One way to consult and update route data is through a cloud database server, or a server installed on the corporate network. If there is a new version of the route, it is updated. The operator then chooses one of the routes and executes the same. When it reports completion, the device returns to the state where it awaits new route updates and/or opens options for choosing other routes to continue carrying out the round. If nothing happens, the device is turned off after a period of inactivity.

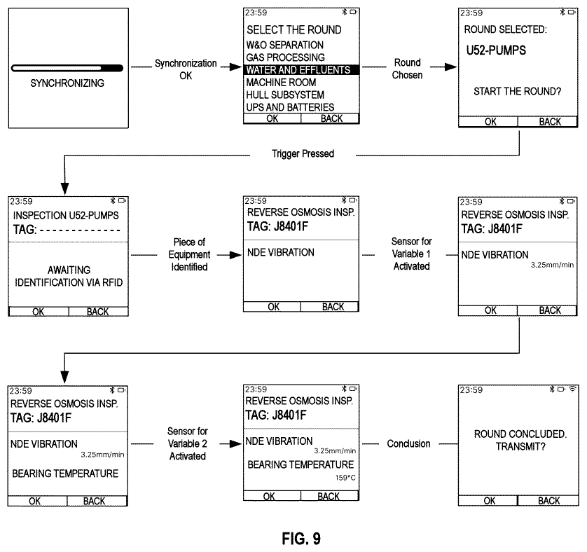

FIG. 9 shows that it is no longer necessary to enter values using the keyboard, since the information is stored as soon as it is read by the sensor and only confirmation by the user is required. The sequence of screens shows steps related to the rounds, represented by FIG. 6. When activating the trigger (2.1) (or tactile button (2.2)), the RFID identification (9) releases the equipment to carry out the round, with the screen (5) of the equipment to be inspected displayed, with the list of the variables on display. At each placement of the sensor (9), the trigger releases the reading of the variable and a confirmation signal, such as vibration, beep or light, which is intended to inform the operator that the variable has been read and has an acceptable value, so that the device can be positioned on the next variable, eliminating the need to stop the activity to view the confirmation on the screen.

An acceptable value of a variable is one with a measured value within a pre-programmed range, or that is within an allowed variation considering the evolution of the time series.

An embodiment of the present disclosure integrates a sound peripheral such as a microphone, using APIs that allow observations to be made for abnormalities, without having to write on paper or type on an alphanumeric keyboard. FIG. 6 shows this use case. When activating a specific command, the operator is taken to a screen where it is possible to save short spoken notes, via audio recording.

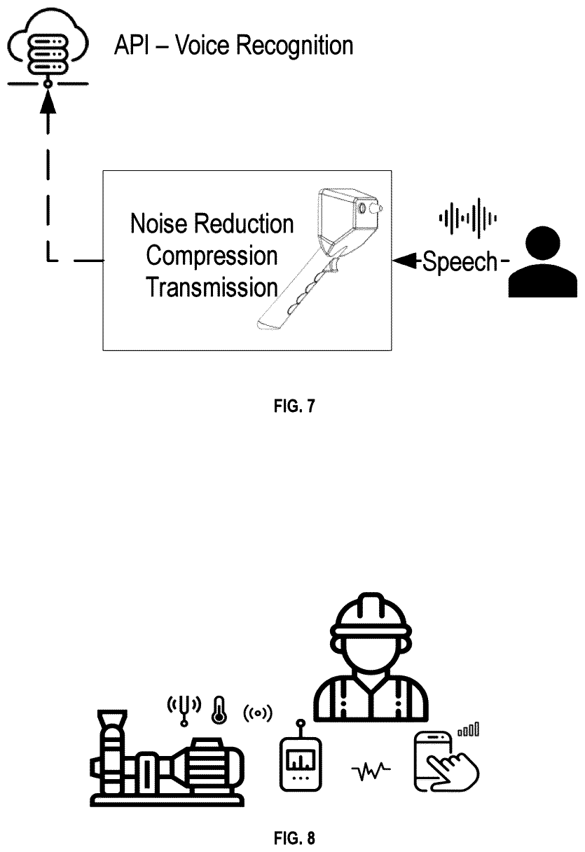

As shown in FIG. 7, after noise reduction using a digital signal processing method, preferably Spectral Gating, the audio is compressed and sent via network to an API. The API uses machine learning models for audio transcription and returns the recording for viewing by the operator and for storage in text format for later consultation.

The software of the device (1) has a logic system with the microcontroller and communicates via a Wi-Fi or Bluetooth communication device, allowing the acquisition of route data or route updates, with uploading of data collected on the routes to servers or synchronization with a smartphone.

Alternatively, the present disclosure can update routes via Bluetooth stored on the Smartphone, once the same has already been synchronized or updated, being used as a repository of information.

The embodiment of the present disclosure aimed at reducing the maintenance costs of the device in relation to the solutions available in the state of the art due to the simplicity of the on-board electronics. In addition, the number of protection circuits is reduced because there is only one port for charging the equipment, which is specified by the IEC 61000 standard, and the level of protection is suitable for a manufacturing environment. The present disclosure was designed to have no physical network port, no parallel pinout of a docking station, and also because it does not have a pen that could possibly be lost, nor is it mandatory to have a touch screen, and consequently the external film of the screen is not worn by the pen.

### Example 1 of Use

FIG. 9 shows an embodiment of the execution of the collection of information from the equipment and the interaction screens with the operator. In the specified example, the first step is the synchronization of the routes with the server after login. Soon after, the route is selected, which can be an inspection of uninterruptible power supply systems, water and oil separation equipment or pump inspection. In this case, the selected route is that of the pumps of the Water and Effluent unit U52, and the operator then confirms that he/she will start the round.

Once in front of the equipment, he/she triggers the RFID identification of the equipment. After identification, the device directs the operator to enter the data of the identified pump, whose TAG is J8401F. First, he/she measures the vibration on the opposite side of the coupling when pressing the trigger. After confirmation by audible signal that the reading was performed successfully, and within the acceptable value of 3.25 mm/min, the operator positions the device to measure the bearing temperature. The temperature indication of 159° C. appears on the display, and the audible signal produced by the piezoelectric device indicates that an acceptable value is played again. If necessary, the operator checks the reading on two sensors and sends the data. Since the sensor stores the numerical information, there is no need to enter values by the operator, and thus the time for collecting information is significantly reduced, and the interaction time with the on-board device drops from 30 seconds, on average, to 5 seconds per piece of equipment.

1. An electronic device for carrying out rounds and automatic data acquisition, the device comprising:
a body containing on-board electronics;
a screen embedded in the body, having an electronic system positioned therein, the electronic system including power control electronics for energy management associated with the use of rechargeable lithium-ion cells, an information processing and storage system, controls for controlling sensors and actuators, an interface with biometric reader with on-board fingerprint identification algorithm, and I/O voltage controllers, the screen also having information I/O capacity to communicate with a controller board;
a rod fixed to the body, the rod having a trigger-type button creating an ornamental gun appearance;
wherein the interface has a sound acquisition device containing a MEMS-type sensor, has direct current vibration micromotors, visual LEDs and piezoelectric-type sound indicators;
an RFID sensor for identifying the equipment and reading operating parameters through a tag and the communication occurs via radio waves;
software having a logic system for a microcontroller and communication through a network communication device such as Wi-Fi and/or Bluetooth, allowing acquisition of route data or updating of the route, with uploading of the data collected in the routes to the servers; and
audio processing circuits for use of microphone and speaker, with the aid of algorithms for noise reduction, wherein the software allows for sound or visual alerts, and has an API that allows recording the transcription of spoken notes.

2. The device according to claim 1, wherein the interface with biometric reader comprises capacitive, which captures an image of the fingerprint and identifies the user.

3. The device according to claim 1, wherein the on-board software allows programming routes with several location points and several acquisition points.

4. The device according to claim 1, further comprising a sound acquisition system, where it has a signal processing method, with noise reduction, so that the audio is compressed and sent via network to an API, returning a voice transcription in text.

5. The device according to claim 1, further comprising a button for more frequent use in the form of a tactile key.

6. A system according to the device of claim 1, wherein the system includes push-type buttons having 2 or 4 pins located at the top of the screen.

7. A method for carrying out rounds and automatic data acquisition, according to the device of claim 1, wherein the method comprises:
when pressing the trigger, the device is initialized;
as soon as the device is ready, it actively searches for route updates by consulting a higher layer of a network server when connected to a gateway;
if there is a new version of the route, it is updated via download;
when choosing one of the routes, carrying out the performance of the route;
when informed of completion of the route, the device enters the state again in which the device awaits new route updates or opens options for choosing other routes to continue carrying out the round;
selecting a round specifying the chosen unit;
carrying out the round;
indicating the completion of the chosen round; and
if nothing else happens, the device is turned off after a period of inactivity.

8. The method according to claim 7, wherein the method uses a maximum of five interface interactions regardless of how many variables are being measured at a given point on the route.

9. The method according to claim 7, wherein the carrying out of the round is in accordance with the following steps:
a. the device starts the round;
b. The user by means of sound acquisition of the device records an audio;
c. directing the device toward the local RFID sensor, thereby to identify the equipment tag;
d. reading the variable data by use of the RFID sensor and pressing the trigger button, directing the reading sensor toward the equipment sensor, which may be one or more sensors;
e. displaying on the screen the measured value and indicating by the device interface whether the value is within normal limits;
f. moving to the next variable to be measured or continuing to display the collected information;
g. confirming the information and ending the round.
